(19) United States
(12) Patent Application Publication
(10) Pub. No.: US 2024/0288263 A1
(43) Pub. Date: Aug. 29, 2024

(54) OPTICAL COHERENCE TOMOGRAPHY IMAGING APPARATUS, OPTICAL COHERENCE TOMOGRAPHY IMAGING METHOD, AND RECORDING MEDIUM

(71) Applicant: NEC Corporation, Minato-ku, Tokyo (JP)

(72) Inventor: Shigeru NAKAMURA, Tokyo (JP)

(73) Assignee: NEC Corporation, Minato-ku, Tokyo (JP)

(21) Appl. No.: 18/571,402

(22) PCT Filed: Jun. 28, 2021
(86) PCT No.: PCT/JP2021/024337

§ 371 Date: Dec. 18, 2023

(51) Int. Cl. G01B 9/02091

(52) U.S. Cl. CPC G01B 9/02091

(57) ABSTRACT

An optical coherence tomography imaging apparatus includes: a wavelength-swept laser light source; a branching unit that divides a light emitted from the wavelength-swept laser light source into a plurality of lights; and a plurality of units that obtain tomographic information on a different measurement target by using each of the plurality of lights outputted from the branching unit. Each of the plurality of units includes: a branching/generation unit that generates an object light and a reference light; a light beam scanning unit that applies the object light to the measurement target; a signal generation unit that generates an electric signal in accordance with intensity of an interference light obtained by allowing interference of the object light scattered by the measurement target and the reference light; and an information generation unit that generates the tomographic information on the measurement target on the basis of the electric signal.

### TECHNICAL FIELD

This disclosure relates to technical fields of an optical coherence tomography imaging apparatus and an optical coherence tomography imaging method that perform optical coherence tomography, and a recording medium.

### BACKGROUND ART

An optical coherence tomography (OCT) technology/technique is known as a technology/technique of performing tomographic imaging of a vicinity of a surface of a measurement target. For example, Patent Literature 1 discloses a technology/technique in which 3-dimensional shape data on a cornea are calculated by using the OCT technology/technique. Patent Literature 2 discloses a technology/technique in which OCT scanning is performed in a probe for an ophthalmic surgery to generate an electronic image of a tissue. Patent Literature 3 discloses that a light from a light source may be divided by two fiber couplers when a tomographic image indicating a layer structure of a retina is created by using the OCT technology/technique.

### CITATION LIST

### Patent Literature

Patent Literature 1: JP2006-051101A
Patent Literature 2: JP2014-503268A
Patent Literature 3: JP2015-221091A

### SUMMARY

### Technical Problem

This disclosure aims to improve the techniques/technologies disclosed in Citation List.

### Solution to Problem

An optical coherence tomography imaging apparatus according to an example aspect of this disclosure includes: a wavelength-swept laser light source; a branching unit that divides a light emitted from the wavelength-swept laser light source into a plurality of lights; and a plurality of units that obtain tomographic information on a different measurement target by using each of the plurality of lights outputted from the branching unit, wherein each of the plurality of units includes: a branching/generation unit that generates an object light and a reference light by dividing the lights outputted from the branching unit; a light beam scanning unit that applies the object light to the measurement target; a signal generation unit that generates an electric signal in accordance with intensity of an interference light obtained by allowing interference of the object light scattered by the measurement target and the reference light; and an information generation unit that generates the tomographic information on the measurement target on the basis of the electric signal.

An optical coherence tomography imaging method according to an example aspect of this disclosure is an optical coherence tomography imaging method that is executed by a computer, the optical coherence tomography imaging method including: emitting a light from a wavelength-swept laser light source; dividing the light emitted from the wavelength-swept laser light source into a plurality of lights; and obtaining tomographic information on a different measurement target in each of a plurality of units, by using each of the plurality of lights, wherein each of the plurality of units: generates an object light and a reference light by further dividing the plurality of lights; applies the object light to the measurement target; generates an electric signal in accordance with intensity of an interference light obtained by allowing interference of the object light scattered by the measurement target and the reference light; and generates the tomographic information on the measurement target on the basis of the electric signal.

A recording medium according to an example aspect of this disclosure is a recording medium on which a computer program that allows a computer to execute an optical coherence tomography imaging method is executed, the optical coherence tomography imaging method including: emitting a light from a wavelength-swept laser light source; dividing the light emitted from the wavelength-swept laser light source into a plurality of lights; and obtaining tomographic information on a different measurement target in each of a plurality of units, by using each of the plurality of lights, wherein each of the plurality of units: generates an object light and a reference light by further dividing the plurality of lights; applies the object light to the measurement target; generates an electric signal in accordance with intensity of an interference light obtained by allowing interference of the object light scattered by the measurement target and the reference light; and generates the tomographic information on the measurement target on the basis of the electric signal.

### BRIEF DESCRIPTION OF DRAWINGS

FIG. 1 is a block diagram illustrating a hardware configuration of an optical coherence tomography imaging apparatus according to a first example embodiment.

FIG. 2 is a block diagram illustrating a configuration of the optical coherence tomography imaging apparatus according to the first example embodiment.

FIG. 3 is a block diagram illustrating a configuration of an optical coherence tomography imaging apparatus according to a second example embodiment.

FIG. 4 is a block diagram illustrating a configuration of an optical coherence tomography imaging apparatus according to a third example embodiment.

FIG. 5 is a block diagram illustrating a configuration of an optical coherence tomography imaging apparatus according to a fourth example embodiment.

FIG. 6 is a block diagram illustrating a configuration of an optical coherence tomography imaging apparatus according to a fifth example embodiment.

FIG. 7 is a block diagram illustrating a configuration of an optical coherence tomography imaging apparatus according to a sixth example embodiment.

FIG. 8 is a block diagram illustrating a configuration of an optical coherence tomography imaging apparatus according to a seventh example embodiment.

FIG. 9 is a block diagram illustrating a configuration of an optical coherence tomography imaging apparatus according to an eighth example embodiment.

FIG. 10 is a schematic diagram illustrating a configuration when an optical coherence tomography imaging apparatus according to a ninth example embodiment is applied to a contact fingerprint scanner.

FIG. 11 is version 1 of a schematic diagram illustrating a configuration when the optical coherence tomography imaging apparatus according to the ninth example embodiment is applied to a contactless fingerprint scanner.

FIG. 12 is version 2 of a schematic diagram illustrating a configuration when the optical coherence tomography imaging apparatus according to the ninth example embodiment is applied to the contactless fingerprint scanner.

### DESCRIPTION OF EXAMPLE EMBODIMENTS

Hereinafter, an optical coherence tomography imaging apparatus, an optical coherence tomography imaging method, and a recording medium according to example embodiments will be described with reference to the drawings.

### First Example Embodiment

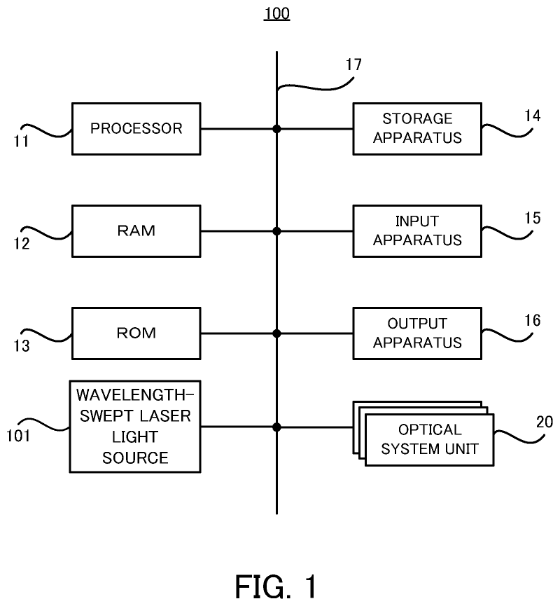

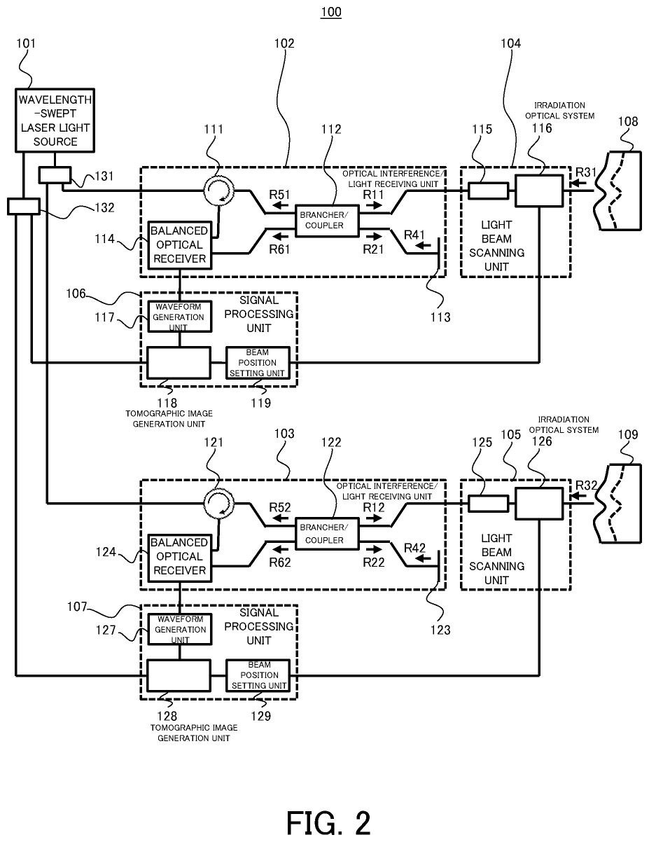

An optical coherence tomography imaging apparatus according to a first example embodiment will be described with reference to FIG. 1 and FIG. 2.

### (Hardware Configuration)

First, with reference to FIG. 1, a hardware configuration of an optical coherence tomography imaging apparatus 100 according to the first example embodiment will be described. FIG. 1 is a block diagram illustrating the hardware configuration of the optical coherence tomography imaging apparatus according to the first example embodiment.

As illustrated in FIG. 1, the optical coherence tomography imaging apparatus 100 according to the first example embodiment includes a processor 11, a RAM (Random Access Memory) 12, a ROM (Read Only Memory) 13, and a storage apparatus 14. The optical coherence tomography imaging apparatus 100 may further include an input apparatus 15 and an output apparatus 16. Furthermore, the optical coherence tomography imaging apparatus 100 according to the first example embodiment includes a wavelength-swept laser light source 101 and a plurality of optical system units 20. The processor 11, the RAM 12, the ROM 13, the storage apparatus 14, the input apparatus 15, the output apparatus 16, the wavelength-swept laser light source 101, and the plurality of optical system units 20 may be connected through a data bus 17.

The processor 11 reads a computer program. For example, the processor 11 is configured to read a computer program stored by at least one of the RAM 12, the ROM 13, and the storage apparatus 14. Alternatively, the processor 11 may read a computer program stored in a computer-readable recording medium by using a not-illustrated recording medium reading apparatus. The processor 11 may obtain (i.e., read) a computer program from a not-illustrated apparatus disposed outside the optical coherence tomography imaging apparatus 100, through a network interface. The processor 11 controls the RAM 12, the storage apparatus 14, the input apparatus 15, and the output apparatus 16 by executing the read computer program.

The processor 11 may be configured as, for example, a CPU (Central Processing Unit), a GPU (Graphics Processing Unit), a FPGA (field-programmable gate array), a DSP (Demand-Side Platform) or an ASIC (Application Specific Integrated Circuit). The processor 11 may be one of them, or may use a plurality of them in parallel.

The RAM 12 temporarily stores the computer program to be executed by the processor 11. The RAM 12 temporarily stores the data that are temporarily used by the processor 11 when the processor 11 executes the computer program. The RAM 12 may be, for example, a D-RAM (Dynamic RAM).

The ROM 13 stores the computer program to be executed by the processor 11. The ROM 13 may otherwise store fixed data. The ROM 13 may be, for example, a P-ROM (Programmable ROM).

The storage apparatus 14 stores the data that are stored for a long term by the optical coherence tomography imaging apparatus 100. The storage apparatus 14 may operate as a temporary storage apparatus of the processor 11. The storage apparatus 14 may include, for example, at least one of a hard disk apparatus, a magneto-optical disk apparatus, a SSD (Solid State Drive), and a disk array apparatus.

The input apparatus 15 is an apparatus that receives an input instruction from a user of the optical coherence tomography imaging apparatus 100. The input apparatus 15 may include, for example, at least one of a keyboard, a mouse, and a touch panel. The input apparatus 15 may be configured as a portable terminal such as a smartphone or a tablet terminal.

The output apparatus 16 is an apparatus that outputs information about the optical coherence tomography imaging apparatus 100 to the outside. For example, the output apparatus 16 may be a display apparatus (e.g., a display) that is configured to display the information about the optical coherence tomography imaging apparatus 10. The output apparatus 16 may be an apparatus that is configured to audio-output the information about the optical coherence tomography imaging apparatus 10 (e.g., a speaker). The output apparatus 16 may be configured as a portable terminal such as a smartphone or a tablet terminal.

The wavelength-swept laser light source 101 is a light source that is configured to generate a laser light with a continuously changed wavelength. The optical coherence tomography imaging apparatus 100 according to this example embodiment is configured to capture a tomographic image of a measurement target, by utilizing coherence of the laser light emitted from the wavelength-swept laser light source 101.

The optical system unit 20 is configured as a unit including a plurality of optical members. The optical system unit 20 is configured to guide the light emitted from the wavelength-swept laser light source 101 to the measurement target, and also to generate an interference light by allowing interference of the lights scattered by the measurement target. A more specific configuration of the optical system unit 20 will be described later. Especially in this example embodiment, a plurality of optical system units 20 are provided for one wavelength-swept laser light source 101.

### (Specific Configuration and Operation of Each Unit)

Next, with reference to FIG. 2, a specific configuration and operation of each unit of the optical coherence tomography imaging apparatus 100 according to the first example embodiment will be described. FIG. 2 is a block diagram illustrating the configuration of the optical coherence tomography imaging apparatus according to the first example embodiment.

In FIG. 2, the optical coherence tomography imaging apparatus 100 according to the first example embodiment is configured as an apparatus that is capable of capturing tomographic images of measurement targets 108 and 109, by using the light emitted from the wavelength-swept laser light source 101. The optical coherence tomography imaging apparatus 100 according to this example embodiment is especially configured to branch/split/divide and output (a light from) one wavelength-swept laser light source 101 to a plurality of units, and to capture the tomographic images of different measurement targets (here, the measurement targets 108 and 109) in each unit.

Specifically, a light pulse emitted from the wavelength-swept laser light source 101 is branched/split/divided by an optical brancher (splitter/divider) 131, and is then supplied to each of a first unit and a second unit, wherein the first unit includes an optical interference/light receiving unit 102, a light beam scanning unit 104, and a signal processing unit 106, and the second unit includes an optical interference/light receiving unit 103, a light beam scanning unit 105, and a signal processing unit 107. The first unit obtains the tomographic image of the measurement target 108, while the second unit obtains the tomographic image of the measurement target 109.

The wavelength-swept laser light source 101 generates a light pulse with a wavelength that is increased from 1250 nm to 1350 nm in a duration of 10 μs, for example, and generates the light pulse at a repetition frequency of 50 kHz every 20 μs.

The light that is emitted from the wavelength-swept laser light source 101 and that is supplied to the optical interference/light receiving unit 102 of the first unit through the optical brancher 131, is applied to and scattered by the measurement target 108 through the light beam scanning unit 104. A part of this scattered light returns to the optical interference/light receiving unit 102 and is subjected to photoelectric conversion. An electric signal outputted from the optical interference/light receiving unit 102 is converted into tomographic image data by the signal processing unit 106, thereby to obtain the tomographic image of the measurement target 108.

Furthermore, the light that is emitted from the wavelength-swept laser light source 101 and that is supplied to the optical interference/light receiving unit 103 of the second unit through the optical brancher 131, is applied to and scattered by the measurement target 109 through the light beam scanning unit 105. A part of this scattered light returns to the optical interference/light receiving unit 103 and is subjected to photoelectric conversion. An electric signal outputted from the optical interference/light receiving unit 103 is converted into tomographic image data by the signal processing unit 107, thereby to obtain the tomographic image of the measurement target 109.

More specifically, the light supplied to the optical interference/light receiving unit 102 of the first unit is inputted to a brancher/coupler 112 through a circulator 111. The light inputted to the brancher/coupler 112 is divided into an object light R11 and a reference light R21. The object light R11 is applied to the measurement target 108 through an irradiation optical system 116 including a fiber collimator 115, a scanning mirror, and a lens. An object light R31 scattered by the measurement target 108 returns to the brancher/coupler 112. On the other hand, the reference light R21 returns to the brancher/coupler 112 through a reference light mirror 113. Therefore, in the brancher/coupler 112, the object light R31 scattered from the measurement target 108 and a reference light R41 reflected from the reference light mirror 113 interfere, thereby to generate an interference light R51 and an interference light R61. That is, an intensity ratio between the interference light R51 and the interference light R61 is determined by a phase difference between the object light R31 and the reference light R41.

The interference light R51 is inputted to a two-input balanced optical receiver 114 through the circulator 111, and the interference light R61 is directly inputted to the balanced optical receiver 114. From the balanced optical receiver 114, voltage corresponding to an intensity difference between the interference light R51 and the interference light R61 is outputted, and is inputted to a light spectrum data generation/A-scan waveform generation unit 117 that is included in the signal processing unit 106.

The balanced optical receiver 114 is an optical receiver in which two photodiodes are connected in series and the connection is an output (differential output). Furthermore, the balanced optical receiver 114 has a band that is less than or equal to 1 GHz.

The light spectrum data generation/A-scan waveform generation unit 117 generates interference light spectrum data, on the basis of information about a wavelength change of the emitted light from the wavelength-swept laser light source 101 and information about a change in the intensity ratio between the interference light R51 and the interference light R61. The light spectrum data generation/A-scan waveform generation unit 117 performs a Fourier transform on the generated interference light spectrum data, and obtains data indicating intensity of a backscattered light (an object light) at different positions in a depth direction (Z direction) (hereinafter, an operation of obtaining data indicating the intensity of the backscattered light (the object light) in the depth direction (Z direction) at a certain position of the measurement target 108 will be referred to as an “A scan”).

In order to generate an A-scan waveform every 20 us that is a repetition period of the light pulse, an electric signal of a repetition frequency of 50 kHz is supplied as a trigger signal from the wavelength-swept laser light source 101 to the signal processing unit 106 through a tomographic image generation unit 118. The trigger signal is outputted from the wavelength-swept laser light source 101, is then divided by a trigger signal brancher 132, and is then supplied to the tomographic image generation unit 118 and a tomographic image generation unit 128.

In consideration of the interference of the reference light and the object light with a wavenumber of wave number k(=2π/2), when an optical path length from when the reference light is divided by the brancher/coupler 112 is reflected to when it is reflected by the reference light mirror 113 and returns to the brancher/coupler 112 is P_{R}, and an optical path length from when the object light is divided by the brancher/coupler 112 to when it is backscattered at one light scattering point of the measurement target 108 and returns to the brancher/coupler 112 is P_{S}=P_{R}+Z₀, the object light R31 and the reference light R41 that interfere on the brancher/coupler 112, interfere with each other at a phase difference of kz₀+φ. Here, φ is a constant independent of k or z₀. When the object light R31 and the reference light R41 that interfere on the brancher/coupler 112 respectively have an amplitude of E_{S} and an amplitude of E_{R}, the intensity difference between the interference light R51 and the interference light R61 is as in the following Equation (1).

$$\begin{matrix}[ Equation 1 ] & \\ I ( k ) ∝ {E}_{S} \cdot {E}_{R} \cdot cos ( {kz}_{0} + ϕ ) & ( 1 )\end{matrix}$$

That is, modulation in a period of 2π/z₀ appears in interference light spectrum data I(k) obtained by measurement from a wavenumber of k₀−Δk/2 to a wavenumber of k₀+Δk/2.

Amplitude J(z) of a Fourier transform of I(k) is as in the following Equation (2).

$$\begin{matrix}[ Equation 2 ] & \\ J ( z ) = \vert \int I ( k ) {e}^{izk} dk \vert ∝ δ ( z - {z}_{0} ) + δ ( z + {z}_{0} ) & ( 2 )\end{matrix}$$

This reflects a light scattering point location z₀ and indicates a δ-function-like peak at z=Z₀ (and z=−z₀).

When the measurement target is a mirror, there is one light scattering point. However, usually, the object light applied to the measurement target is sequentially backscattered while attenuating and propagating to the inside to a certain extent, and the light scattering points of the object light are distributed in a range of a certain depth from the surface. When the light scattering points are distributed from z₀−Δz to z₀+Δz in the depth direction, the modulation in a period of 2π/(z₀−Δz) to 2π/(Z₀+Δz) appears overlapping in the interference light spectrum.

Furthermore, an irradiation position of the object light R31 is scanned on the measurement target 108 by the irradiation optical system 116. A beam position setting unit 119 controls the irradiation optical system 116 to move the irradiation position of the object light R31 in a scanning line direction (X direction) in accordance with the trigger signal supplied through the tomographic image generation unit 118. By repeating an A-scan operation and by connecting A-scan measurement results in the tomographic image generation unit 118, a map of the intensity of a two-dimensional backscattered light (an object light) in the scanning line direction and the depth direction is obtained as tomographic data (hereinafter, an operation of repeating the A-scan operation in the scanning line direction (X direction) and connecting the measurement results, will be referred to as a “B-scan”).

Furthermore, by repeating a B-scan operation while moving the irradiation position of the object light R31 not only in the scanning line direction but also in a direction (Y direction) perpendicular to the scanning line by using the irradiation optical system 116, and by connecting A (B?)-scan measurement results in the tomographic image generation unit 118, three-dimensional tomographic data are obtained (hereinafter, an operation of repeating the B-scan operation in the direction (Y direction) perpendicular to the scanning line and connecting the measurement results, will be referred to as a C-scan).

The tomographic data on the measurement target 109 are obtained in the same procedure (i.e., in the same procedure as that in the first unit described above) even in the second unit.

### (Technical Effect)

Next, a technical effect obtained by the optical coherence tomography imaging apparatus 100 according to the first example embodiment will be described.

As described in FIG. 1 and FIG. 2, in the optical coherence tomography imaging apparatus 100 according to the first example embodiment, the light emitted from one wavelength-swept laser light source 101 is distributed to a plurality of units, and the measurement is performed. In this way, it is possible obtain the tomographic data on the measurement target in each unit, while sharing a high-cost wavelength-swept laser light source with the plurality of units. Consequently, it is possible to reduce an apparatus cost.

### Second Example Embodiment

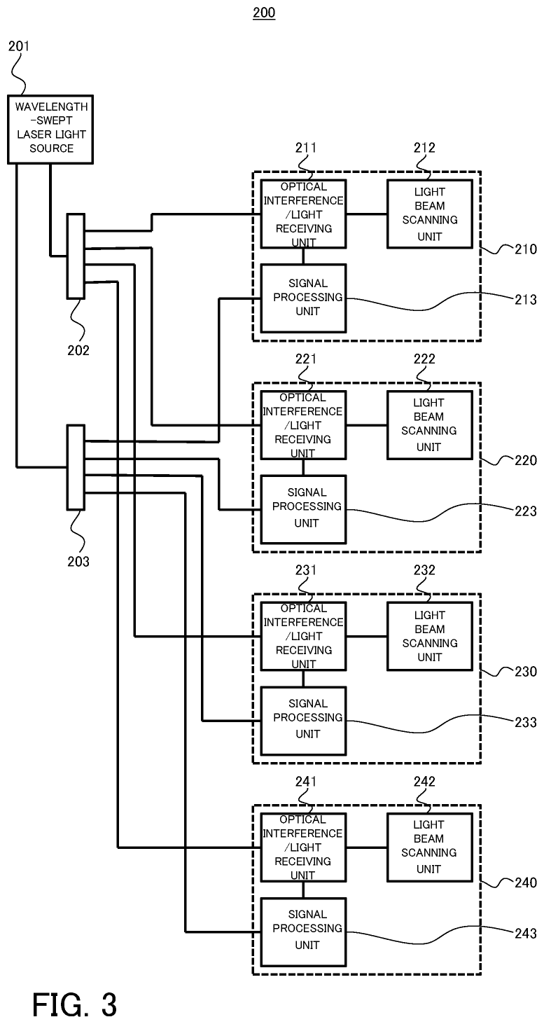

An optical coherence tomography imaging apparatus 200 according to a second example embodiment will be described with reference to FIG. 3. The second example embodiment is partially different from the first example embodiment only in the configuration and operation, and may be the same as the first example embodiment in the other parts. For this reason, a part that is different from the first example embodiment described above will be described in detail below, and a description of other overlapping parts will be omitted as appropriate.

### (Specific Configuration and Operation of Each Unit)

First, with reference to FIG. 3, a specific configuration and operation of each unit of the optical coherence tomography imaging apparatus 200 according to the second example embodiment will be described. FIG. 3 is a block diagram illustrating the configuration of the optical coherence tomography imaging apparatus according to the second example embodiment. In FIG. 3, the detailed components included in the optical interference/light receiving unit, the light beam scanning unit, and the signal processing unit illustrated in FIG. 2 are not illustrated.

As illustrated in FIG. 3, the optical coherence tomography imaging apparatus 200 according to the second example embodiment includes four units 210, 220, 230, and 240, as input destinations of the light emitted from a wavelength-swept laser light source 201. As described above, the number of the units to which a plurality of types of divided lights are inputted, is not particularly limited. Thus, the number of the units may be, for example, 5, 6, or more.

In the optical coherence tomography imaging apparatus 200 according to the second example embodiment, the light emitted from the wavelength-swept laser light source 201 is divided into four lights by an optical brancher 202. Then, each of the divided lights is supplied to an optical interference/light receiving unit 211 of the first unit 210, an optical interference/light receiving unit 221 of the second unit 220, an optical interference/light receiving unit 231 of the third unit 230, and an optical interference/light receiving unit 241 of the fourth unit 240.

The light inputted to the optical interference/light receiving unit 211 of the first unit 210 is used for scanning by a light beam scanning unit 212. The light inputted to the optical interference/light receiving unit 221 of the second unit 220 is used for scanning by a light beam scanning unit 222. The light inputted to the optical interference/light receiving unit 231 of the third unit 230 is used for scanning by a light beam scanning unit 232. The light inputted to the optical interference/light receiving unit 241 of the fourth unit 240 is used for scanning by a light beam scanning unit 242. This enables each unit to obtain the tomographic data on different measurement targets (here, four measurement targets).

The trigger signal outputted from the wavelength-swept laser light source 201 is also divided by a trigger signal brancher 203 and is supplied to a signal processing unit 213 of the unit 210, a signal processing unit 223 of the unit 220, a signal processing unit 233 of the unit 230, and a signal processing unit 243 of the unit 240.

### (Technical Effect)

Next, a technical effect obtained by the optical coherence tomography imaging apparatus 200 according to the second example embodiment will be described.

As described in FIG. 3, in the optical coherence tomography imaging apparatus 200 according to the second example embodiment, the light emitted from one wavelength-swept laser light source 101 is distributed to more units than those in the first example embodiment and the measurement is performed. In this way, the high-cost wavelength-swept laser light source may be shared by more units. Consequently, it is possible to reduce an apparatus cost.

### Third Example Embodiment

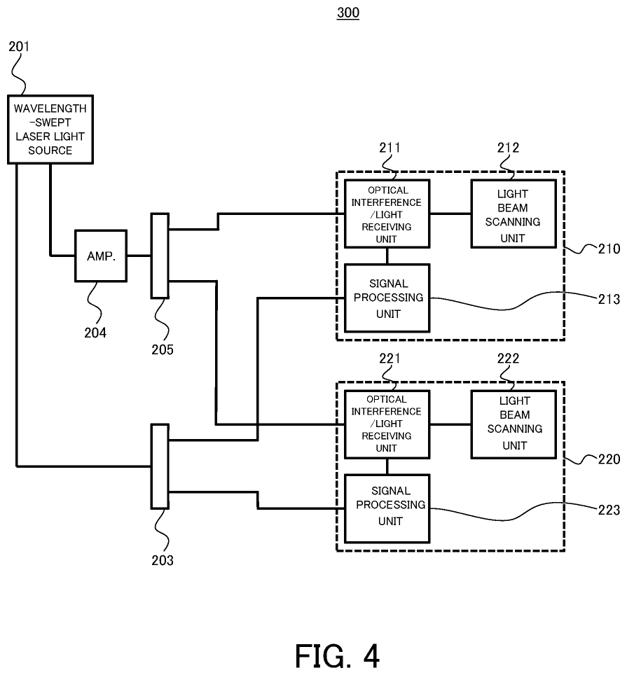

An optical coherence tomography imaging apparatus 300 according to a third example embodiment will be described with reference to FIG. 4. The third example embodiment is partially different from the first and second example embodiments only in the configuration and operation, and may be the same as the first and second example embodiments in the other parts. For this reason, a part that is different from each of the example embodiments described above will be described in detail below, and a description of other overlapping parts will be omitted as appropriate.

### (Specific Configuration and Operation of Each Unit)

First, with reference to FIG. 4, a specific configuration and operation of each unit of the optical coherence tomography imaging apparatus 300 according to the third example embodiment will be described. FIG. 4 is a block diagram illustrating the configuration of the optical coherence tomography imaging apparatus according to the third example embodiment. In FIG. 4, the same components as those illustrated in FIG. 3 carry the same reference numerals.

As illustrated in FIG. 4, the optical coherence tomography imaging apparatus 300 according to the third example embodiment includes an optical amplifier 204 that amplifies a light pulse emitted from the wavelength-swept laser light source 201. In operation of the optical coherence tomography imaging apparatus 300, first, the light pulse emitted from the wavelength-swept laser light source 201 is amplified by the optical amplifier 204. Then, the amplified light is divided into two by an optical brancher 205. Each of the divided lights by the optical brancher 205 is supplied to respective one of the optical interference/light receiving unit 211 of the first unit 210 and the optical interference/light receiving unit 221 of the second unit 220.

### (Technical Effect)

Next, a technical effect obtained by the optical coherence tomography imaging apparatus 300 according to the third example embodiment will be described.

As described in FIG. 4, in the optical coherence tomography imaging apparatus 300 according to the third example embodiment, the light pulse emitted from the wavelength-swept laser light source 201 is amplified before division/split/branching. In this way, a reduction in power of the light pulse due to the branching may be compensated by amplification. Therefore, for example, even when the number of branches is large and the power of the light pulse after the branching is insufficient as it is, it is possible to compensate the power by the amplification, and to properly capture the tomographic image.

### Fourth Example Embodiment

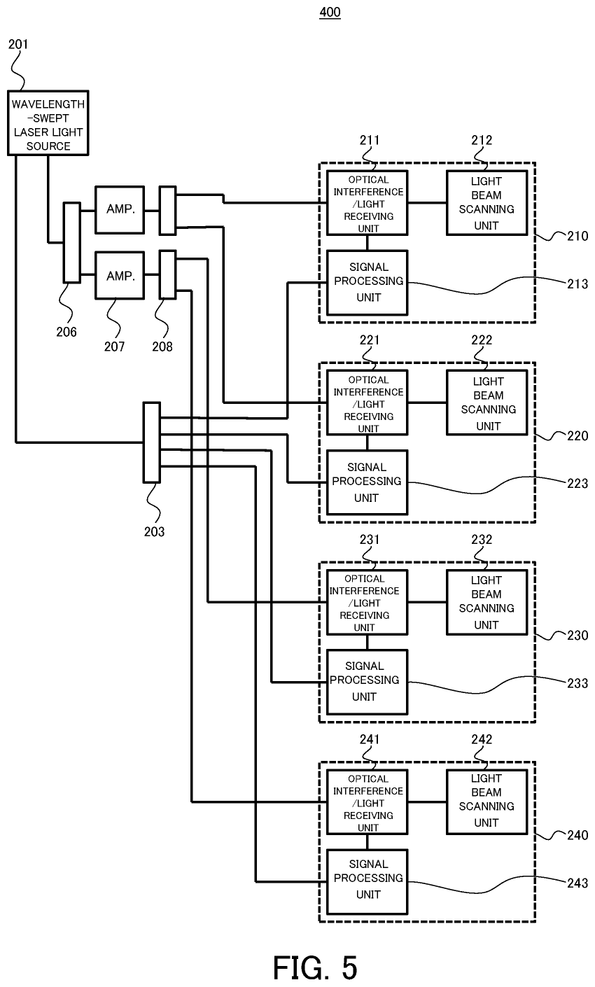

An optical coherence tomography imaging apparatus 400 according to a fourth example embodiment will be described with reference to FIG. 5. The fourth example embodiment is partially different from the first to third example embodiments only in the configuration and operation, and may be the same as the first to third example embodiments in the other parts. For this reason, a part that is different from each of the example embodiments described above will be described in detail below, and a description of other overlapping parts will be omitted as appropriate.

### (Specific Configuration and Operation of Each Unit)

First, with reference to FIG. 5, a specific configuration and operation of each unit of the optical coherence tomography imaging apparatus 400 according to the fourth example embodiment will be described. FIG. 5 is a block diagram illustrating the configuration of the optical coherence tomography imaging apparatus according to the fourth example embodiment. In FIG. 5, the same components as those illustrated in FIG. 3 and FIG. 4 carry the same reference numerals.

As illustrated in FIG. 5, the optical coherence tomography imaging apparatus 400 according to the fourth example embodiment includes a first optical brancher 206 that divides the light pulse emitted from the wavelength-swept laser light source 201, two optical amplifiers 207 each of which amplifies respective one of the divided lights by the first optical brancher, and second optical branchers 208 each of which further divides each of the light amplified by respective one of the optical amplifiers 207.

In operation of the optical coherence tomography imaging apparatus 300, first, the light pulse emitted from the wavelength-swept laser light source 201 is divided into two lights by the first optical brancher 206. Then, the two divided lights are respectively supplied to the two optical amplifiers 207. In the optical amplifiers 207, the two lights obtained by the division by first optical brancher 206 are respectively amplified. Then, the two lights amplified by the optical amplifiers 207 are respectively supplied to the second optical branchers 208. The second optical brancher 208 further divides the inputted light into two.

As a result of the above, the light pulse emitted from the wavelength-swept laser light source 201 is divided into four lights through the first optical brancher 206, the optical amplifiers 207, and through the second optical branchers 208. The four lights emitted from the second optical branchers 208 are supplied, as in the second example embodiment, to the optical interference/light receiving portion 211 of the first unit 210, the optical interference/light receiving portion 221 of the second unit 220, the optical interference/light receiving portion 231 of the third unit 230, and the optical interference/light receiving portion 241 of the fourth unit 240.

### (Technical Effect)

Next, a technical effect obtained by the optical coherence tomography imaging apparatus 400 according to the fourth example embodiment will be described.

As described in FIG. 5, in the optical coherence tomography imaging apparatus 400 according to the fourth example embodiment, the light pulse is divided in stages through the amplification. In this way, when the light pulse is divided into a relatively large number of light pulses, it is possible to properly divide and amplify the light pulse. The fourth example embodiment describes an example of dividing the light pulse in two stages, but the light pulse may be divided in three or more stages. In this case, the amplification may be performed before the branching at each step (i.e., multiple amplification may be performed in stages).

### Fifth Example Embodiment

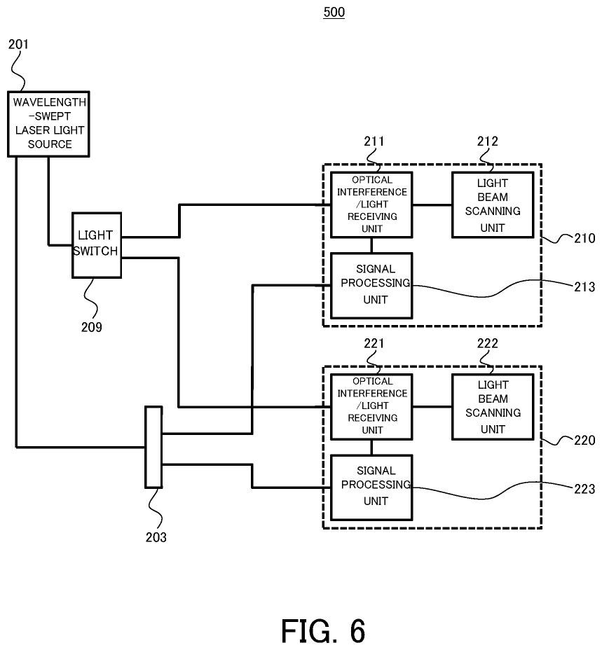

An optical coherence tomography imaging apparatus 500 according to a fifth example embodiment will be described with reference to FIG. 6. The fifth example embodiment is partially different from the first to fourth example embodiments only in the configuration and operation, and may be the same as the first to fourth example embodiments in the other parts. For this reason, a part that is different from each of the example embodiments described above will be described in detail below, and a description of other overlapping parts will be omitted as appropriate.

### (Specific Configuration and Operation of Each Unit)

First, with reference to FIG. 6, a specific configuration and operation of each unit of the optical coherence tomography imaging apparatus 500 according to the fifth example embodiment will be described. FIG. 6 is a block diagram illustrating the configuration of the optical coherence tomography imaging apparatus according to the fifth example embodiment. In FIG. 6, the same components as those illustrated in FIG. 3 to FIG. 5 carry the same reference numerals.

As illustrated in FIG. 6, the optical coherence tomography imaging apparatus 500 according to the fifth example embodiment includes a light switch 209, as an element for dividing the light pulse emitted from the wavelength-swept laser light source 201. The light switch 209 is configured to allow time-division and branching of the wavelength-swept laser light source 201 (i.e., to switch an optical path by timing).

In operation of the optical coherence tomography imaging apparatus 400, the light switch 209 is switched such that the light pulse emitted from the wavelength-swept laser light source 201 is sequentially supplied to the units 210 and 220. For example, first, the light switch 209 is switched such that the light pulse is supplied to the optical interference/light receiving unit 211 of the first unit 210. Thereafter, the light switch 209 is switched such that the light pulse is supplied to the optical interference/light receiving unit 221 of the second unit 220. By repeating such a series of operations, it is possible to sequentially supply the light pulse emitted from the wavelength-swept laser light source 101, to each of the units 210 and 220.

### (Technical Effect)

Next, a technical effect obtained by the optical coherence tomography imaging apparatus 500 according to the fifth example embodiment will be described.

As described in FIG. 6, in the optical coherence tomography imaging apparatus 500 according to the fifth example embodiment, the light pulse emitted from the wavelength-swept laser light source 201 is divided by the light switch 209. In this way, a reduction in power of the light pulse due to the branching may be reduced. Therefore, for example, it is possible to maintain the power of the light pulse after the branching, even without the optical amplifier as in the third and fourth example embodiments.

### Sixth Example Embodiment

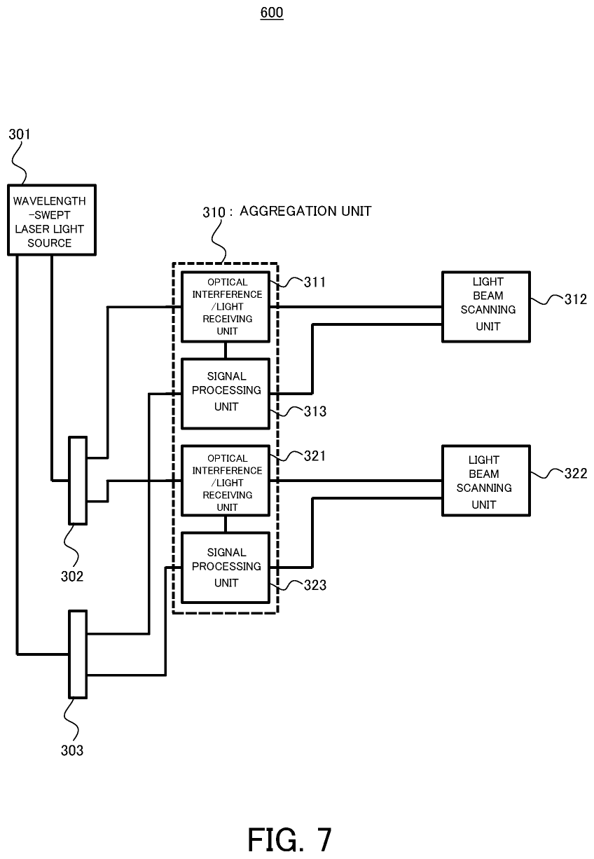

An optical coherence tomography imaging apparatus 600 according to a sixth example embodiment will be described with reference to FIG. 7. The sixth example embodiment is partially different from the first to fifth example embodiments only in the configuration and operation, and may be the same as the first to fifth example embodiments in the other parts. For this reason, a part that is different from each of the example embodiments described above will be described in detail below, and a description of other overlapping parts will be omitted as appropriate.

### (Specific Configuration and Operation of Each Unit)

First, with reference to FIG. 7, a specific configuration and operation of each unit of the optical coherence tomography imaging apparatus 600 according to the sixth example embodiment will be described. FIG. 7 is a block diagram illustrating the configuration of the optical coherence tomography imaging apparatus according to the sixth example embodiment.

As illustrated in FIG. 7, in the optical coherence tomography imaging apparatus 600 according to the sixth example embodiment, optical interference/light receiving units and signal processing units in a plurality of units are configured as one common aggregation unit 310. Specifically, the aggregation unit 310 includes optical interference/light receiving units 311 and 321, and signal processing units 313 and 323.

The light pulse divided by the optical brancher 302 is supplied to each of the optical interference/light receiving units 311 and 321 included in the aggregation unit 310. Furthermore, the trigger signal divided by the trigger signal brancher 303 is supplied to each of the signal processing units 313 and 323 included in the aggregation unit 310.

A plurality of light beam scanning units 312 and 322 are remotely disposed in the aggregation unit 310. The plurality of light beam scanning units 312 and 322 are configured to operate through the respective different optical interference/light receiving units and signal processing units included in the aggregation unit 310. The light beam scanning units 312 and 322 are configured to scan a plurality of respective target objects that are different from each other.

### (Technical Effect)

Next, a technical effect obtained by the optical coherence tomography imaging apparatus 600 according to the sixth example embodiment will be described.

As described in FIG. 7, in the optical coherence tomography imaging apparatus 600 according to the sixth example embodiment, the plurality of optical interference/light receiving units and the plurality of signal processing units are configured as the one common aggregation unit 310. In this way, it is possible to simplify the apparatus configuration and to reduce an increase in cost, as compared with those when the optical interference/light receiving unit and the signal processing unit are configured as separate units (e.g., in the first to fifth example embodiments).

### Seventh Example Embodiment

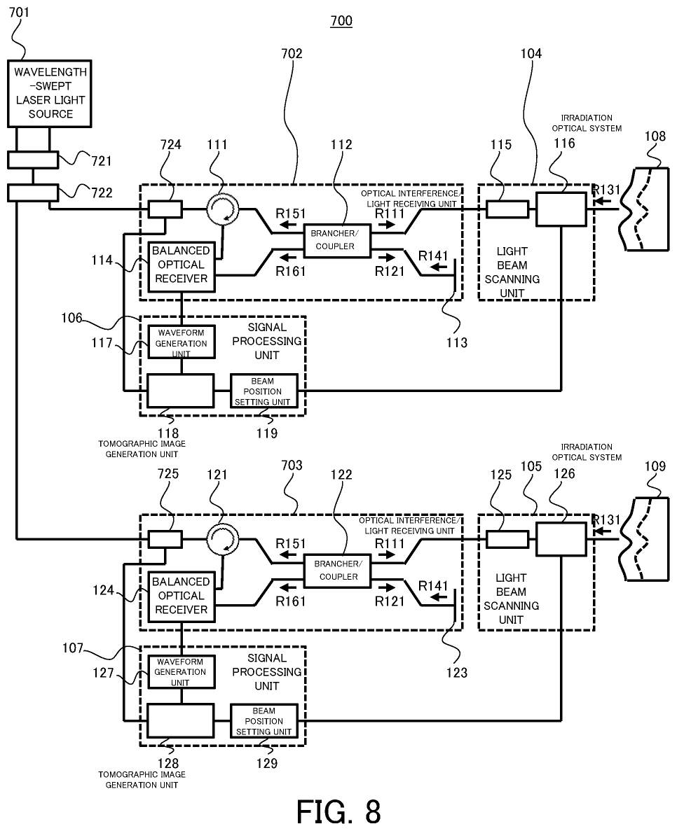

An optical coherence tomography imaging apparatus 700 according to a seventh example embodiment will be described with reference to FIG. 8. The seventh example embodiment is partially different from the first to sixth example embodiments only in the operation, and may be the same as the first to sixth example embodiments in the other parts. For this reason, a part that is different from each of the example embodiments described above will be described in detail below, and a description of other overlapping parts will be omitted as appropriate.

### (Specific Configuration and Operation of Each Unit)

First, with reference to FIG. 8, a specific configuration and operation of each unit of the optical coherence tomography imaging apparatus 700 according to the seventh example embodiment will be described. FIG. 8 is a block diagram illustrating the configuration of the optical coherence tomography imaging apparatus according to the seventh example embodiment.

As illustrated in FIG. 8, the optical coherence tomography imaging apparatus 700 according to the seventh example embodiment includes an optical coupler 721 and an optical brancher 722. The optical coupler 721 is configured to couple and output a wavelength-swept first light pulse and a second light pulse. The optical brancher 722 is configured to divide and output the light coupled by the optical coupler 721.

In the optical coherence tomography imaging apparatus 700 according to the seventh example embodiment, the wavelength-swept first light pulse and the second light pulse that is synchronized with the repetition of the first light pulse are emitted from the wavelength-swept laser light source 701. For example, the wavelength-swept first light pulse is generated with a wavelength that is increased from 1250 nm to 1350 nm in a duration of 10 μs, and at a repetition frequency of 50 kHz every 20 μs. In synchronization with this, the second light pulse is generated in a band of a wavelength of 1550 nm at a repetition frequency of 50 kHz.

In operation of the optical coherence tomography imaging apparatus 700, the first light pulse and the second light pulse are coupled by the optical coupler 721 and the coupled light is divided by the optical brancher 722. When the first light pulse and the second light pulse have different wavelength bands, the optical coupler 721 is allowed to reduce a light loss at the time of coupling by using a wavelength multiplexer. The divided lights by the optical brancher 722 are respectively supplied to a first unit including optical interference/light receiving unit 702, the light beam scanning unit 104, and the signal processing unit 106, and to a second unit including an optical interference/light receiving unit 703, the light beam scanning unit 105, and the signal processing unit 107.

In the first unit, the light that is emitted from the wavelength-swept laser light source 701 and that is supplied to the optical interference/light receiving unit 702 through the optical coupler 721 and the optical brancher 722, is inputted to a trigger signal separation unit 724. When the first light pulse and the second light pulse have different wavelength bands, the first light pulse and the second light pulse are separated while reducing the light loss at the time of the separation by using a wavelength demultiplexer, and then, the first light pulse is guided to the circulator 111, and the second light pulse is subjected to photoelectric conversion by the optical receiver. The first light pulse is used to obtain the tomographic data on the measurement target 108 in the same manner as in the first example embodiment (see FIG. 2). An electric signal obtained by the photoelectric conversion of the second light pulse is inputted to the tomographic image generation unit 118 of the signal processing unit 106, as in the first example embodiment.

Even in the second unit, the tomographic data on the measurement target 109 is obtained in the same manner (i.e., in the same manner as in the first unit).

### (Technical Effect)

Next, a technical effect obtained by the optical coherence tomography imaging apparatus 700 according to the seventh example embodiment will be described.

As described in FIG. 8, in the optical coherence tomography imaging apparatus 700 according to the seventh example embodiment, the first pulse and the second pulse are separated in each unit (specifically, by the trigger signal separation units 724 and 725 in each unit). In this way, it is not necessary to separately supply each unit with the light pulse for generating the object light and the reference light, and the light pulse for the trigger signal. Therefore, it is not necessary to separately provide thee optical brancher and the trigger signal brancher at a prior stage of each unit, for example.

### Eighth Example Embodiment

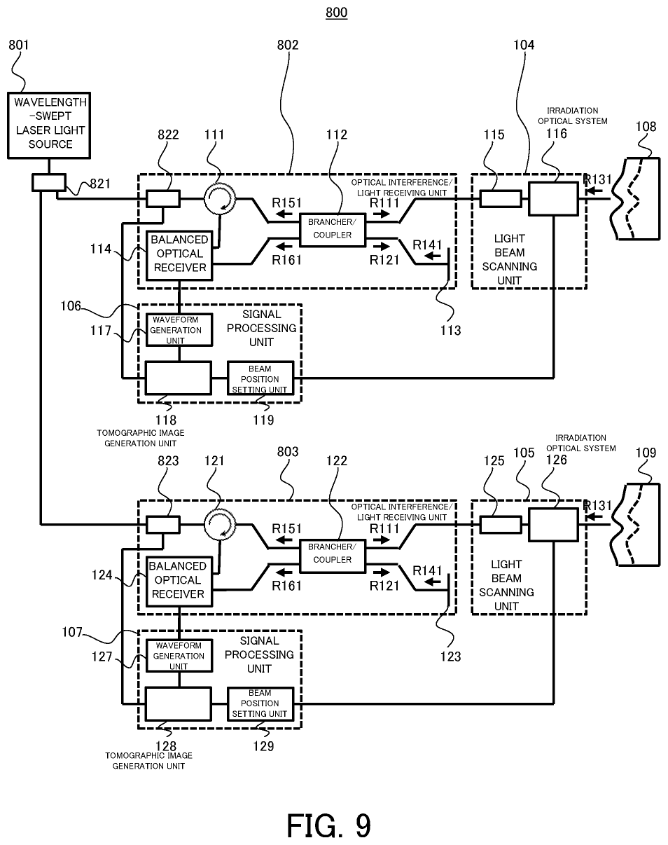

An optical coherence tomography imaging apparatus 800 according to an eighth example embodiment will be described with reference to FIG. 9. The eighth example embodiment is partially different from the first to seventh example embodiments only in the operation, and may be the same as the first to seventh example embodiments in the other parts. For this reason, a part that is different from each of the example embodiments described above will be described in detail below, and a description of other overlapping parts will be omitted as appropriate.

### (Specific Configuration and Operation of Each Unit)

First, with reference to FIG. 9, a specific configuration and operation of each unit of the optical coherence tomography imaging apparatus 800 according to the eighth example embodiment will be described. FIG. 9 is a block diagram illustrating the configuration of the optical coherence tomography imaging apparatus according to the eighth example embodiment.

As illustrated in FIG. 9, in the optical coherence tomography imaging apparatus 800 according to the eighth example embodiment, each unit includes respective one of trigger signal extraction units 822 and 823. The trigger signal extraction units 822 and 823 are configured to generate an electrical signal that is synchronized with the light pulse, by dividing a part of the power of the light pulse and performing the photoelectric conversion.

In operation of the optical coherence tomography imaging apparatus 800, the light pulse is emitted from a wavelength-swept laser light source 801 and is supplied to a first unit including an optical interference/light receiving unit 802, the light beam scanning unit 104, and the signal processing unit 106, and to a second unit including an optical interference/light receiving unit 803, the light beam scanning unit 105, and the signal processing unit 107.

In the first unit, one of the divided lights by the optical brancher 821 is supplied to the optical interference/light receiving unit 802. The light pulse supplied to the optical interference/light receiving unit 802 is inputted to the trigger signal extraction unit 822. The trigger signal extraction unit 822 divides a part of the power of the light pulse and performs the photoelectric conversion, thereby to generate an electrical signal that is synchronized with the light pulse. A majority of the remaining power of the light pulse is used to obtain the tomographic data on the measurement target 108 in the same manner as in the first example embodiment (see FIG. 2). The electric signal obtained by the trigger signal extraction unit 822 is inputted to the tomographic image generation unit 118 of the signal processing unit 106 as the trigger signal.

Even in the second unit, the tomographic data on the measurement target 109 is obtained in the same manner (i.e., in the same manner as in the first unit).

### (Technical Effect)

Next, a technical effect obtained by the optical coherence tomography imaging apparatus 800 according to the eighth example embodiment will be described.

As described in FIG. 9, in the optical coherence tomography imaging apparatus 800 according to the eighth example embodiment, the separation is performed in each unit (specifically, in the trigger signal extraction units 822 and 823 of the respective units). In this way, it is not necessary to separately supply each unit with the light pulse for generating the object light and the reference light, and the light pulse for the trigger signal. Therefore, it is not necessary to separately provide the optical brancher and the trigger signal brancher at a prior stage of each unit, for example.

### Ninth Example Embodiment

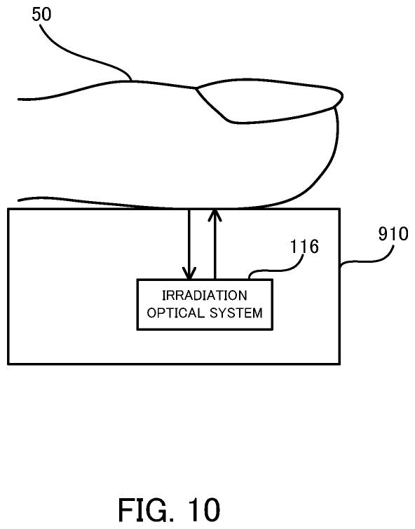

An optical coherence tomography imaging apparatus according to a ninth example embodiment will be described with reference to FIG. 10 to FIG. 12. The ninth example embodiment describes specific application examples of the optical coherence tomography imaging apparatus according to the first to eighth example embodiments, and may be the same as the first to eighth example embodiments in the basic configuration and operation of the apparatus. For this reason, a part that is different from each of the example embodiments described above will be described in detail below, and a description of other overlapping parts will be omitted as appropriate.

### (Contact Fingerprint Scanner)

First, a configuration when the optical coherence tomography imaging apparatus according to the ninth example embodiment is applied to a contact fingerprint scanner will be described with reference to FIG. 10. FIG. 10 is a schematic diagram illustrating the configuration when the optical coherence tomography imaging apparatus according to the ninth example embodiment is applied to the contact fingerprint scanner. In FIG. 10, the same components as those illustrated in FIG. 2 carry the same reference numerals.

As illustrated in FIG. 10, the optical coherence tomography imaging apparatus according to the ninth example embodiment may be applied to the contact fingerprint scanner (i.e., an apparatus that reads a fingerprint by bringing a finger into contact with the apparatus). In this instance, a scanning unit 910 to be touched by a finger 50 of a living body may include the irradiation optical system 116. The irradiation optical system 116 applies a light beam to the finger 50 of the living body that is in contact with the scanning unit 910. Then, a scattered light scattered by the finger 50 of the living body enters the irradiation optical system 116. On the basis of the scattered light, an image of the fingerprints is generated in the contact fingerprint scanner.

As already described, the laser light emitted from the wavelength-swept laser light source 101 is divided and supplied to the irradiation optical system 116. Therefore, although it is not illustrated here, a plurality of scanning units 910 may be provided for one wavelength-swept laser light source 101.

### (Contactless Fingerprint Scanner)

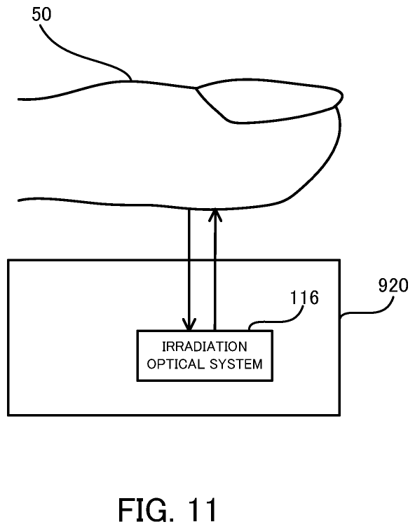

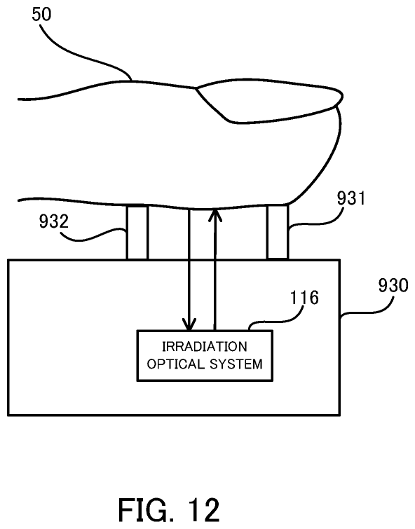

Next, a configuration when the optical coherence tomography imaging apparatus according to the ninth example embodiment is applied to a contactless fingerprint scanner will be described with reference to FIG. 11 and FIG. 12. FIG. 11 is version 1 of a schematic diagram illustrating the configuration when the optical coherence tomography imaging apparatus according to the ninth example embodiment is applied to the contactless fingerprint scanner. FIG. 12 is version 2 of a schematic diagram illustrating the configuration when the optical coherence tomography imaging apparatus according to the ninth example embodiment is applied to the contactless fingerprint scanner. In FIG. 11 and FIG. 12, the same components as those illustrated in FIG. 2 carry the same reference numerals.

As illustrated in FIG. 11, the optical coherence tomography imaging apparatus according to the ninth example embodiment may be applied to the contactless fingerprint scanner (i.e., an apparatus that reads a fingerprint without bringing a finger into contact with the apparatus). In this instance, a scanning unit 920 over which the finger 50 of the living body is to be held, may include the irradiation optical system 116. The irradiation optical system 116 applies the light beam to the finger 50 of the living body that is not in contact with the scanning unit 920. Then, the scattered light scattered by the finger 50 of the living body enters the irradiation optical system 116. On the basis of the scattered light, the image of the fingerprints is generated in the contactless fingerprint scanner.

As illustrated in FIG. 12, the optical coherence tomography imaging apparatus according to the ninth example embodiment may be applied to a guided contactless fingerprint scanner. In this instance, a scanning unit 930 over which the finger 50 of the living body is to be held, includes guiding parts 931 and 932 for placing thereon the finger 50 of the living body. In this way, even when the finger 50 of living body is brought into contact with the guiding parts 931 and 932, the scanning unit 930 is not in contact with the finger 50 of the living body (i.e., it is possible to maintain a contactless condition).

As in the case of the contact scanner, the laser light emitted from the wavelength-swept laser light source 101 is also divided and supplied to the irradiation optical system 116 in the contactless scanner. Thus, although it is not illustrated here, a plurality of scanning units 920 or 930 may be provided for one wavelength-swept laser light source 101.

### (Technical Effect)

Next, a technical effect obtained by the optical coherence tomography imaging apparatus according to the ninth example embodiment will be described.

As described in FIG. 10 to FIG. 12, the optical coherence tomography imaging apparatus according to the ninth example embodiment is applied to the contact fingerprint scanner or the contactless fingerprint scanner. In this way, it is possible to obtain a fingerprint image of the finger 50 of the living body in each unit, while the high-cost wavelength-swept laser light source 101 is shared by a plurality of units. Thus, for example, even when there is only one wavelength-swept lasers 101, it is possible to simultaneously obtain a plurality of fingerprint images of the living body.

A processing method in which a program for allowing the configuration in each of the example embodiments to operate so as to realize the functions of each example embodiment is recorded on a recording medium, and in which the program recorded on the recording medium is read as a code and executed on a computer, is also included in the scope of each of the example embodiments. That is, a computer-readable recording medium is also included in the range of each of the example embodiments. Not only the recording medium on which the above-described program is recorded, but also the program itself is also included in each example embodiment.

The recording medium to use may be, for example, a floppy disk (registered trademark), a hard disk, an optical disk, a magneto-optical disk, a CD-ROM, a magnetic tape, a nonvolatile memory card, or a ROM. Furthermore, not only the program that is recorded on the recording medium and executes processing alone, but also the program that operates on an OS and executes processing in cooperation with the functions of expansion boards and another software, is also included in the scope of each of the example embodiments.

This disclosure is not limited to the examples described above and is allowed to be changed, if desired, without departing from the essence or spirit of this disclosure which can be read from the claims and the entire specification. An optical coherence tomography imaging apparatus, an optical coherence tomography imaging method, and a recording medium with such changes are also intended to be within the technical scope of this disclosure.

### <Supplementary Notes>

The example embodiments described above may be further described as, but not limited to, the following Supplementary Notes below.

### (Supplementary Note 1)

An optical coherence tomography imaging apparatus according to Supplementary Note 1 is an optical coherence tomography imaging apparatus including: a wavelength-swept laser light source; a branching unit that divides a light emitted from the wavelength-swept laser light source into a plurality of lights; and a plurality of units that obtain tomographic information on a different measurement target by using each of the plurality of lights outputted from the branching unit, wherein each of the plurality of units includes: a branching/generation unit that generates an object light and a reference light by dividing the lights outputted from the branching unit; a light beam scanning unit that applies the object light to the measurement target; a signal generation unit that generates an electric signal in accordance with intensity of an interference light obtained by allowing interference of the object light scattered by the measurement target and the reference light; and an information generation unit that generates the tomographic information on the measurement target on the basis of the electric signal.

### (Supplementary Note 2)

An optical coherence tomography imaging apparatus according to Supplementary Note 2 is the optical coherence tomography imaging apparatus according to Supplementary Note 1, wherein the branching unit amplifies the light emitted from the wavelength-swept laser light source, and divides the amplified light into a plurality of lights.

### (Supplementary Note 3)

An optical coherence tomography imaging apparatus according to Supplementary Note 3 is the optical coherence tomography imaging apparatus according to Supplementary Note 1, wherein the branching unit divides the light emitted from the wavelength-swept laser light source, amplifies the divided lights, and further divides the amplified lights and outputs them as the plurality of lights.

### (Supplementary Note 4)

An optical coherence tomography imaging apparatus according to Supplementary Note 4 is the optical coherence tomography imaging apparatus according to any one of Supplementary Notes 1 to 3, wherein the branching unit allows time-division of the light emitted from the wavelength-swept laser light source and outputs them as the plurality of lights.

### (Supplementary Note 5)

An optical coherence tomography imaging apparatus according to Supplementary Note 5 is the optical coherence tomography imaging apparatus according to any one of Supplementary Notes 1 to 4, wherein the branching/generation unit, the signal generation unit, and the information generation unit are configured as one aggregation unit that is shared among the plurality of units.

### (Supplementary Note 6)

An optical coherence tomography imaging apparatus according to Supplementary Note 6 is the optical coherence tomography imaging apparatus according to any one of Supplementary Notes 1 to 5, wherein the wavelength-swept laser light source emits a first light pulse and a second light pulse, the branching unit divides a light obtained by coupling the first light pulse and the second light pulse, and outputs them as the plurality of lights, and each of the plurality of units further includes a separation unit that separates the lights outputted from the branching unit into the first light pulse and the second light pulse, that outputs the first light pulse as a light for generating the object light and the reference light, and that outputs the second light pulse as a trigger signal that is a trigger for the signal generation unit to generate the tomographic information.

### (Supplementary Note 7)

An optical coherence tomography imaging apparatus according to Supplementary Note 7 is the optical coherence tomography imaging apparatus according to any one of Supplementary Notes 1 to 5, wherein each of the plurality of units further includes an extraction unit that extracts a trigger signal that is a trigger for the signal generation unit to generate the tomographic information, by separating a part of power of the lights outputted from the branching unit and performing photoelectric conversion.

### (Supplementary Note 8)

An optical coherence tomography imaging method according to Supplementary Note 8 is an optical coherence tomography imaging method that is executed by a computer, the optical coherence tomography imaging method including: emitting a light from a wavelength-swept laser light source; dividing the light emitted from the wavelength-swept laser light source into a plurality of lights; and obtaining tomographic information on a different measurement target in each of a plurality of units, by using each of the plurality of lights, wherein each of the plurality of units: generates an object light and a reference light by further dividing the plurality of lights; applies the object light to the measurement target; generates an electric signal in accordance with intensity of an interference light obtained by allowing interference of the object light scattered by the measurement target and the reference light; and generates the tomographic information on the measurement target on the basis of the electric signal.

### (Supplementary Note 9)

A recording medium according to Supplementary Note 9 is a recording medium on which a computer program that allows a computer to execute an optical coherence tomography imaging method is executed, the optical coherence tomography imaging method including: emitting a light from a wavelength-swept laser light source; dividing the light emitted from the wavelength-swept laser light source into a plurality of lights; and obtaining tomographic information on a different measurement target in each of a plurality of units, by using each of the plurality of lights, wherein each of the plurality of units: generates an object light and a reference light by further dividing the plurality of lights; applies the object light to the measurement target; generates an electric signal in accordance with intensity of an interference light obtained by allowing interference of the object light scattered by the measurement target and the reference light; and generates the tomographic information on the measurement target on the basis of the electric signal.

### (Supplementary Note 10)

A computer program according to Supplementary Note 9 is a computer program that allows a computer to execute an optical coherence tomography imaging method, the optical coherence tomography imaging method including: emitting a light from a wavelength-swept laser light source; dividing the light emitted from the wavelength-swept laser light source into a plurality of lights; and obtaining tomographic information on a different measurement target in each of a plurality of units, by using each of the plurality of lights, wherein each of the plurality of units: generates an object light and a reference light by further dividing the plurality of lights; applies the object light to the measurement target; generates an electric signal in accordance with intensity of an interference light obtained by allowing interference of the object light scattered by the measurement target and the reference light; and generates the tomographic information on the measurement target on the basis of the electric signal.

### DESCRIPTION OF REFERENCE CODES

100 Optical coherence tomography imaging apparatus
101 Wavelength-swept laser light source
102 Optical interference/light receiving unit
104 Light beam scanning unit
108 Measurement target
111 Circulator
112 Brancher/coupler
113 Reference light mirror
115 Fiber collimator
116 Irradiation optical system
117 Light spectrum data generation/A-scan waveform generation unit
118 Tomographic image generation unit
119 Beam position setting unit
131 Optical brancher
132 Trigger signal brancher
204 Optical amplifier
205 Optical brancher
206 First optical brancher
207 Optical amplifier
208 Second optical brancher
209 Light switch
310 Aggregation unit
721 Optical coupler
722 Optical brancher
724 Trigger signal separation unit
822 Trigger signal extraction unit
910, 920, 930 Scanning unit
931, 932 Guiding part

What is claimed is:

1. An optical coherence tomography imaging apparatus comprising:
at least one memory that is configured to store instructions; and
at least one processor that is configured to execute the instructions to:
emit a light from a wavelength-swept laser light source;
divide the light emitted from the wavelength-swept laser light source into a plurality of lights; and
obtain tomographic information on a different measurement target in each of a plurality of units, by using each of the plurality of lights, wherein
each of the plurality of units includes:
a branching/generation unit that generates an object light and a reference light by further dividing the plurality of lights;
a light beam scanning unit that applies the object light to the measurement target;
a signal generation unit that generates an electric signal in accordance with intensity of an interference light obtained by allowing interference of the object light scattered by the measurement target and the reference light; and
an information generation unit that generates the tomographic information on the measurement target on the basis of the electric signal.

2. The optical coherence tomography imaging apparatus according to claim 1, wherein the at least one processor is configured to execute the instructions to amplify the light emitted from the wavelength-swept laser light source, and divide the amplified light into a plurality of lights.

3. The optical coherence tomography imaging apparatus according to claim 1, wherein the at least one processor is configured to execute the instructions to divide the light emitted from the wavelength-swept laser light source, amplify the divided lights, and further divide the amplified lights and output them as the plurality of lights.

4. The optical coherence tomography imaging apparatus according to claim 1, wherein the at least one processor is configured to execute the instructions to allows time-division of the light emitted from the wavelength-swept laser light source and output them as the plurality of lights.

5. The optical coherence tomography imaging apparatus according to claim 1, wherein the branching/generation unit, the signal generation unit, and the information generation unit are configured as one aggregation unit that is shared among the plurality of units.

6. The optical coherence tomography imaging apparatus according to claim 1, wherein
the at least one processor is configured to execute the instructions to:
emit a first light pulse and a second light pulse from the wavelength-swept laser light source, and
divide a light obtained by coupling the first light pulse and the second light pulse, and output them as the plurality of lights, and
each of the plurality of units further includes a separation unit that separates the plurality of lights into the first light pulse and the second light pulse, that outputs the first light pulse as a light for generating the object light and the reference light, and that outputs the second light pulse as a trigger signal that is a trigger for the signal generation unit to generate the tomographic information.

7. The optical coherence tomography imaging apparatus according to claim 1, wherein each of the plurality of units further includes an extraction unit that extracts a trigger signal that is a trigger for the signal generation unit to generate the tomographic information, by separating a part of power of the plurality of lights and performing photoelectric conversion.

8. An optical coherence tomography imaging method that is executed by a computer, the optical coherence tomography imaging method comprising:
emitting a light from a wavelength-swept laser light source;
dividing the light emitted from the wavelength-swept laser light source into a plurality of lights; and
obtaining tomographic information on a different measurement target in each of a plurality of units, by using each of the plurality of lights, wherein
each of the plurality of units:
generates an object light and a reference light by further dividing the plurality of lights;
applies the object light to the measurement target;
generates an electric signal in accordance with intensity of an interference light obtained by allowing interference of the object light scattered by the measurement target and the reference light; and
generates the tomographic information on the measurement target on the basis of the electric signal.

9. A non-transitory recording medium on which a computer program that allows a computer to execute an optical coherence tomography imaging method is executed, the optical coherence tomography imaging method including:
emitting a light from a wavelength-swept laser light source;
dividing the light emitted from the wavelength-swept laser light source into a plurality of lights; and
obtaining tomographic information on a different measurement target in each of a plurality of units, by using each of the plurality of lights, wherein
each of the plurality of units:
generates an object light and a reference light by further dividing the plurality of lights;
applies the object light to the measurement target;
generates an electric signal in accordance with intensity of an interference light obtained by allowing interference of the object light scattered by the measurement target and the reference light; and
generates the tomographic information on the measurement target on the basis of the electric signal.
